(19) United States
(12) Patent Application Publication
(10) Pub. No.: US 2017/0155114 A1
(43) Pub. Date: Jun. 1, 2017

(54) NONAQUEOUS ELECTROLYTE SECONDARY BATTERY SEPARATOR

(71) Applicant: Sumitomo Chemical Company, Limited, Tokyo (JP)

(72) Inventor: Kosuke KURAKANE, Osaka (JP)

(21) Appl. No.: 15/363,442

(22) Filed: Nov. 29, 2016

(30) Foreign Application Priority Data
Nov. 30, 2015 (JP) 2015-233941
Nov. 17, 2016 (JP) 2016-224481

(51) Int. Cl. H01M 2/16; H01M 10/0525

(52) U.S. Cl. CPC H01M 2/1653; H01M 10/0525; H01M 2/1686

(57) ABSTRACT

A separator is provided which is suitable for a nonaqueous electrolyte secondary battery having an excellent discharge output characteristic. The separator (i) is a porous film containing a polyolefin resin as a main component, (ii) has a piercing strength of equal to or greater than 26.0 gf/g/m², measured based on a weight per unit area of the porous film, and (iii) satisfies the following formula: 0.00≦|1−T/M|≦0.54, where (i) T represents a distance by which the porous film moves in a transverse direction from a starting point of measurement to a point where a critical load is obtained in a scratch test under a constant load of 0.1 N, and (ii) M represents a distance by which the porous film moves in a machine direction from a starting point of measurement to a point where a critical load is obtained in a scratch test under a constant load of 0.1 N.

This Nonprovisional application claims priority under 35 U.S.C. §119 on Patent Application No. 2015-233941 filed in Japan on Nov. 30, 2015 and Patent Application No. 2016-224481 filed in Japan on Nov. 17, 2016, the entire contents of which, are hereby incorporated by reference.

### TECHNICAL FIELD

The present invention relates to (i) a separator for a nonaqueous electrolyte secondary battery (hereinafter referred to as “nonaqueous electrolyte secondary battery separator”), which nonaqueous electrolyte secondary battery separator is a porous film and (ii) a laminated separator for a nonaqueous electrolyte secondary battery (hereinafter referred to as “nonaqueous electrolyte secondary battery laminated separator”), which nonaqueous electrolyte secondary battery laminated separator is prepared by laminating a porous layer on a porous film.

### BACKGROUND ART

Nonaqueous electrolyte secondary batteries, particularly lithium secondary batteries, have a high energy density and are thus in wide use as batteries for personal computers, mobile telephones, portable information terminals, and the like. Such nonaqueous electrolyte secondary batteries have recently been developed as on-vehicle batteries.

Microporous films containing polyolefin as a main component are used as a separator in a nonaqueous electrolyte secondary battery such as a lithium ion secondary battery.

A nonaqueous electrolyte secondary battery poses the following problem: Since electrodes in a nonaqueous electrolyte secondary battery repeat expansion and shrinkage along with charging/discharging of the battery, there occurs stress between the electrodes and a separator. This causes, for example, an electrode active material to fall off, and consequently causes internal resistance to increase, so that a cycle characteristic deteriorates. Under the circumstances, there is a proposed method for increasing adhesion between a separator and electrodes by coating a surface of the separator with an adhesive material such as polyvinylidene fluoride (see Patent Literatures 1 and 2).

### CITATION LIST

### Patent Literature

[Patent Literature 1]

Japanese Patent, No. 5355323 (Publication date: Nov. 27, 2013)

[Patent Literature 2]

Japanese Patent Application Publication Tokukai No. 2001-118558 (Publication date: Apr. 27, 2001)

### SUMMARY OF INVENTION

### Technical Problem

During charge/discharge of a nonaqueous electrolyte secondary battery, expansion and shrinkage of electrodes occur. Then, due to the expansion and shrinkage of the electrodes, there occur (i) a deformation, in a thicknesswise direction, of surface layers of a separator, which surface layers face the respective electrodes and (ii) a force which occurs in a horizontal direction and which occurs at an interface between the separator and an electrode. Therefore, according to the nonaqueous electrolyte secondary battery in which the conventional separator is incorporated, the deformation in the thicknesswise direction and the force in the horizontal direction may cause a decrease in surface-wise uniformity in distance between the electrodes. As a result of the decrease in surface-wise uniformity in distance between the electrodes, deterioration may occur in a rate characteristic of the nonaqueous electrolyte secondary battery after a charge-discharge cycle.

### Solution to Problem

The inventors achieved the present invention by finding that a nonaqueous electrolyte secondary battery separator can have an excellent rate characteristic maintaining ratio after a charge-discharge cycle in a case where the nonaqueous electrolyte secondary battery separator is a porous film whose ratio of a traverse direction-critical load distance (T) measured in a scratch test to a machine direction-critical load distance (M) measured in a scratch test falls within a certain range.

An embodiment of the present invention can encompass (i) a nonaqueous electrolyte secondary battery separator, (ii) a nonaqueous electrolyte secondary battery laminated separator, (iii) a member for a nonaqueous electrolyte secondary battery (hereinafter referred to as “nonaqueous electrolyte secondary battery member”), and (iv) a nonaqueous electrolyte secondary battery.

A nonaqueous electrolyte secondary battery separator in accordance with an embodiment of the present invention is a porous film containing a polyolefin resin as a main component, the nonaqueous electrolyte secondary battery separator having a piercing strength of equal to or greater than 26.0 gf/g/m², which piercing strength is measured with, respect to a weight per unit area of the porous film, and the nonaqueous electrolyte secondary battery separator having a value in a range of 0.00 to 0.54, which value is represented by the following Formula (1):

|1−T/M| (1)

where (i) T represents a distance by which the porous film moves in a traverse direction from a starting point of measurement to a point where a critical load is obtained in a scratch test under a constant load of 0.1 N and (ii) M represents a distance by which the porous film moves in a machine direction from a starting point of measurement to a point where a critical load is obtained in a scratch test under a constant load of 0.1 N.

The nonaqueous electrolyte secondary battery separator in accordance with an embodiment of the present invention is preferably configured so that a value represented by the following Formula (2) is in a range of 0.00 to 0.54:

1−T/M (2)

where (i) T represents a distance by which the porous film moves in a traverse direction from a starting point of measurement to a point where a critical load is obtained in a scratch test under a constant load of 0.1 N and (ii) M represents a distance by which the porous film moves in a machine direction, from a starting point of measurement to a point where a critical load is obtained in a scratch test under a constant load of 0.1 N.

A nonaqueous electrolyte secondary battery laminated separator in accordance with an embodiment of the present invention includes: the nonaqueous electrolyte secondary battery separator in accordance with an embodiment of the present invention; and a porous layer laminated on at least one surface of the nonaqueous electrolyte secondary battery separator.

The nonaqueous electrolyte secondary battery laminated separator in accordance with an embodiment of the present invention is configured so that the porous layer preferably contains a heat-resistant resin, and more preferably contains a polyvinylidene fluoride-based resin. It is preferable that the porous layer further contains electrically insulating fine particles.

A nonaqueous electrolyte secondary battery member in accordance with an embodiment of the present invention includes: (i) a cathode, the nonaqueous electrolyte secondary battery separator in accordance with an embodiment of the present invention or the nonaqueous electrolyte secondary battery laminated separator in accordance with an embodiment of the present invention, and an anode, the cathode, the nonaqueous electrolyte secondary battery separator in accordance with an embodiment of the present invention or the nonaqueous electrolyte secondary battery laminated separator in accordance with an embodiment of the present invention, and the anode being arranged in this order.

A nonaqueous electrolyte secondary battery in accordance with an embodiment of the present invention includes the nonaqueous electrolyte secondary battery separator in accordance with an embodiment of the present invention or the nonaqueous electrolyte secondary battery laminated separator in accordance with an embodiment of the present invention.

### Advantageous Effects of Invention

A nonaqueous electrolyte secondary battery separator in accordance with an embodiment of the present invention and a nonaqueous electrolyte secondary battery laminated separator in accordance with an embodiment of the present invention can each (i) allow a nonaqueous electrolyte secondary battery, which includes the separator, to increase in rate characteristic maintaining ratio after a charge-discharge cycle and (ii) allow the nonaqueous electrolyte secondary battery to have an excellent discharge output characteristic.

### BRIEF DESCRIPTION OF DRAWINGS

FIG. 1 is a view illustrating a device and an operation of the device in a scratch test in accordance with an embodiment of the present invention.

FIG. 2 is a graph which is based on results of a scratch test in accordance with an embodiment of the present invention and which shows a relationship between (i) load values and (ii) distances by which, a porous film moves from a starting point of measurement to a point where the critical load are obtained.

FIG. 3 is a view schematically illustrating a method of further stretching a stretched sheet after the stretched sheet is heat fixed and cooled in each of Examples 3 through 5.

### DESCRIPTION OF EMBODIMENTS

The following description will discuss an embodiment of the present invention in detail. Note that “A to B” herein means “equal to or greater than A and equal to or less than B”.

### Embodiment 1: Nonaqueous Electrolyte Secondary Battery Separator, Embodiment 2: Nonaqueous Electrolyte Secondary Battery Laminated Separator

A nonaqueous electrolyte secondary battery separator in accordance with Embodiment 1 of the present invention is a porous film which (i) contains a polyolefin resin as a main component, (ii) has a piercing strength of equal to or greater than 26.0 gf/g/m², which piercing strength is measured with respect to a weight per unit area of the porous film, and (iii) has a value in a range of 0.00 to 0.54, which value is represented by the following Formula (1):

|1−T/M| (1)

where (i) T represents a distance by which the porous film moves in a transverse direction (TD) from a starting point of measurement to a point where a critical load is obtained in a scratch test under a constant load of 0.1 N and (ii) M represents a distance by which the porous film moves in a machine direction (MD) from a starting point of measurement to a point where a critical load is obtained in a scratch test under a constant load of 0.1 N (these distances may be hereinafter referred to as “critical load distance”).

A nonaqueous electrolyte secondary battery laminated separator in accordance with Embodiment 2 of the present invention includes: the nonaqueous electrolyte secondary battery separator (porous film) in accordance with Embodiment 1 of the present invention; and a porous layer laminated on at least one surface of the nonaqueous electrolyte secondary battery separator (porous film).

<Porous Film>

The porous film in accordance with an embodiment of the present invention can be (i) a nonaqueous electrolyte secondary battery separator or (ii) a base material for a nonaqueous electrolyte secondary battery laminated separator described later. The porous film in accordance with an embodiment of the present invention contains polyolefin as a main component, and has a large number of pores therein, which pores are connected to one another, so that a gas, a liquid, or the like can pass through the porous film from one surface of the porous film to the other.

The concept of “containing polyolefin resin as a main component” herein means that the polyolefin resin is contained in the porous film at a proportion of equal to or greater than 50% by volume, preferably equal to or greater than 90% by volume, and more preferably equal to or greater than 95% by volume of an entire portion of the porous film. The polyolefin resin more preferably contains a high molecular weight component having a weight-average molecular weight of 5×10⁵ to 15×10⁶. The polyolefin resin particularly preferably contains a high molecular weight component having a weight-average molecular weight of equal to or greater than 1,000,000 because such an amount of high molecular weight component allows for an increase in strength of (i) the nonaqueous electrolyte secondary battery separator which is the porous film and (ii) the nonaqueous electrolyte secondary battery laminated separator which serves as a laminated body including the porous film.

Examples of the polyolefin resin which is a main component of the porous film encompass, but are not particularly limited to, homopolymers (for example, polyethylene, polypropylene, and polybutene) and copolymers (for example, ethylene-propylene copolymer) produced through (co)polymerization of a monomer such as ethylene, propylene, 1-butene, 4-methyl-1-pentene, or 1-hexene. Among the above examples, polyethylene is preferable because it is able to prevent (shutdown) the flow of an excessively large current at a lower temperature. Examples of the polyethylene encompass a low-density polyethylene, a high-density polyethylene, a linear polyethylene (ethylene-α-olefin copolymer), and an ultra-high molecular weight polyethylene having a weight-average molecular weight of equal to or greater than 1,000,000. Among these examples, an ultra-high molecular weight polyethylene having a weight-average molecular weight of equal to or greater than 1,000,000 is preferable.

In a case where the porous film itself is to be the nonaqueous electrolyte secondary battery separator, a thickness of the porous film is preferably 4 μμm to 40 μm, more preferably 5 μm to 30 μm, and still more preferably 6 μm to 15 μm. In a case where the porous film is used as a base material for the nonaqueous electrolyte secondary battery laminated separator and where the nonaqueous electrolyte secondary battery laminated separator (laminated body) is formed by laminating the porous layer on one surface or both surfaces of the porous film, the thickness of the porous film is preferably 4 μm to 40 μm, and more preferably 5 μm to 30 μm, although the thickness can be decided as appropriate in view of a thickness of the laminated body.

If the thickness of the porous film is below the above range, then a nonaqueous electrolyte secondary battery, which includes the nonaqueous electrolyte secondary battery separator using the porous film or the nonaqueous electrolyte secondary battery laminated, separator using the porous film, makes it impossible to sufficiently prevent an internal short circuit of the battery, which internal short circuit is caused by breakage or the like of the battery. In addition, an amount of electrolyte solution to be retained by the porous film decreases. In contrast, if the thickness of the porous film is above the range, then there occurs an increase in resistance to permeation of lithium ions all over the nonaqueous electrolyte secondary battery separator using the porous film or all over the nonaqueous electrolyte secondary battery laminated separator using the porous film. This causes a cathode of a nonaqueous electrolyte secondary battery, which includes the separator, to deteriorate in a case where a charge-discharge cycle is repeated. Consequently, a rate characteristic and/or a cycle characteristic deteriorate(s). In addition, since a distance between the cathode and an anode becomes longer, the nonaqueous electrolyte secondary battery becomes large in size.

A weight per unit area of the porous film only needs to be decided as appropriate in view of strength, thickness, weight, and handleability of (i) the nonaqueous electrolyte secondary battery separator serving as the porous film or (ii) the nonaqueous electrolyte secondary battery laminated separator including the porous film. Specifically, the weight per unit area of the porous film is preferably 4 g/m² to 20 g/m², more preferably 4 g/m² to 12 g/m², and still more preferably 5 g/m² to 10 g/m² on an ordinary basis so that the battery, which includes the nonaqueous electrolyte secondary battery separator or the nonaqueous electrolyte secondary battery laminated separator, can have high energy density per unit weight and high energy density per unit volume.

Piercing strength with respect to a weight per unit area of the porous film is preferably equal to or greater than 26.0 gf/g/m², and more preferably equal to or greater than 30.0 gf/g/m³. If the piercing strength is excessively small, that is, if the piercing strength is less than 26.0 gf/g/m², then it may allow the separator to be pierced by cathode active material particles and anode active material particles in a case where, for example, (i) an operation of laminating and winding a cathode, an anode, and the separator is carried out during a battery assembling process, (ii) an operation of pressing and tightening a wound group is carried out during a battery assembling process, or (iii) the battery is pressured from outside. This may cause a short circuit between the cathode and the anode.

Air permeability of the porous film in terms of Gurley values is preferably 30 sec/100 mL to 500 sec/100 mL, and more preferably 50 sec/100 mL to 300 sec/100 mL. In a case where the air permeability of the porous film falls within these ranges, the nonaqueous electrolyte secondary battery separator serving as the porous film or the nonaqueous electrolyte secondary battery laminated separator including the porous film can have sufficient ion permeability.

Porosity of the porous film is preferably 20% by volume to 80% by volume, and more preferably 30% by volume to 75% by volume so that it is possible to increase the amount of electrolyte solution to be retained as well as to obtain a function of reliably preventing (shutting down) the flow of an excessively large current at a lower temperature.

If the porosity of the porous film is below 20% by volume, then a resistance of the porous film increases. If the porosity of the porous film is above 80% by volume, then mechanical strength of the porous film decreases.

A pore size of each of the pores of the porous film is preferably equal to or less than 0.3 μm, and more preferably equal to or less than 0.14 μm so that (i) the nonaqueous electrolyte secondary battery separator serving as the porous film or the nonaqueous electrolyte secondary battery laminated separator including the porous film can have sufficient ion permeability and (ii) it is possible to prevent particles from entering the cathode or the anode.

The porous film in accordance with an embodiment of the present invention has a value represented by the following Formula (1), which value is in a range of 0.00 to 0.54, preferably 0.00 to 0.50, and more preferably 0.00 to 0.45:

|1−T/M| (1)

where (i) T represents a critical load distance in a traverse direction in a scratch test under a constant load of 0.1 N and (ii) M represents a critical load distance in a machine direction in a scratch test under a constant load of 0.1 N.

The porous film in accordance with an embodiment of the present invention also has a value represented by the following Formula (2), which is preferably in a range of 0.00 to 0.54, more preferably 0.00 to 0.50, and still more preferably 0.00 to 0.45:

1−T/M (2)

where (i) T represents a critical load distance in a traverse direction in a scratch test under a constant load of 0.1 N and (ii) M represents a critical load distance in a machine-direction in a scratch test under a constant load of 0.1 N.

The respective values represented by the Formula (1) and the Formula (2) are each a value representing anisotropy of a critical load distance in a scratch test. A value that is close to zero indicates that the critical load distance is more isotropic.

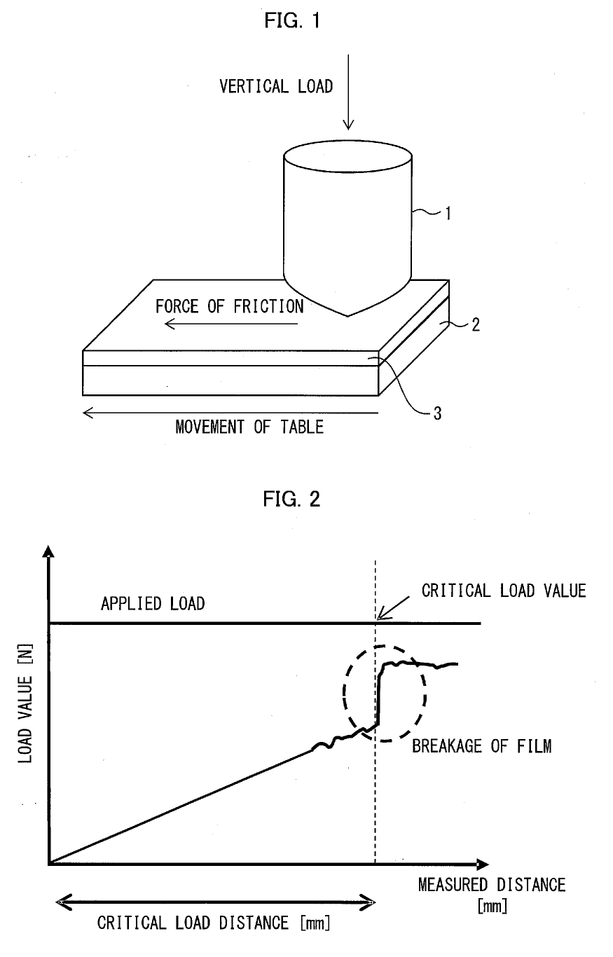

As illustrated in FIG. 1, “scratch test” in accordance with an embodiment of the present invention is a test for measuring stress that occurs in a distance by which an indenter is moved in a horizontal direction while a surface layer of the porous film is subjected to compressive deformation in a thicknesswise direction by applying a certain load to the indenter (i.e. while the indenter is pressed down). Specifically, the scratch test is carried out by the following steps:
(1) A porous film to be measured is cut into a piece of 20 mm×60 mm. Then, a preparation is made by combining the piece of the porous film and a glass plate of 30 mm×70 mm by the use of glue which is (i) obtained by 5-fold dilution of Arabic Yamato aqueous liquid glue (manufactured by YAMATO Co., Ltd.) with the use of water and (ii) thinly applied to an entire surface of the glass plate in as small an amount as weight per unit area of approximately 1.5 g/m². Then, the preparation is dried at a temperature of 25° C. for one whole day and night, so that a test sample is prepared. Note that the piece of the porous film and the glass plate are to be combined with care so that no air bubble is made between the piece of the porous film and the glass plate.
(2) The test sample prepared in the step (1) is placed on a microscratch testing device (manufactured by CSM Instruments). Then, while a diamond indenter (in a conical shape having an apex angle of 120° and having a tip whose radius is 0.2 mm) of the testing device is applying a vertical load of 0.1 N to the test sample, a table of the testing device is moved by a distance of 1.0 mm in a traverse direction of the porous film at a speed of 5 mm/min. During the movement of the table, stress (force of friction) that occurs between the diamond indenter and the test sample is measured.
(3) A line graph, which shows a relationship between a displacement of the stress measured in the step (2) and the distance of the movement of the table, is made. Then, based on the line graph, the following are calculated as illustrated in FIG. 2: (i) a critical load value in the traverse direction and (ii) a distance (critical load distance) in the traverse direction between a starting point of measurement and a point where the critical load is obtained.
(4) The direction of the movement of the table is changed to a machine direction, and the above steps (1) through (3) are repeated. Then, the following are calculated: (i) a critical load value in the machine direction and (ii) the distance (critical load distance) in the machine direction between a starting point of measurement and a point where the critical load is obtained.

Note that any conditions and the like for the measurement in the scratch test other than the conditions described above are similar to those disclosed in JIS R 3255.

The scratch test measures and calculates the following effect in a nonaqueous electrolyte secondary battery in which the porous film to be measured is incorporated as a separator or as a member of a separator. Specifically, the scratch test measures and calculates, by modeling a mechanism of the effect, the effect of expansion of an electrode composite layer during battery charge/discharge (an anode expands during charge, and a cathode expands during discharge) on (i) adhesion at an interface between an expanded electrode and a first surface layer of the separator (porous film) which first surface layer faces the expanded electrode and (ii) adhesion at an interface between a second surface layer and a corresponding electrode, which second surface layer is opposite the first surface layer.

Note that the expansion and shrinkage of the electrode composite layer during charge/discharge causes a surface layer of the separator (porous film), which surface layer faces the expanded electrode, to be deformed (compressive deformation) in a thicknesswise direction by expanded active material particles with which the surface layer is in contact. In addition, the expansion of the composite layer in a horizontal direction causes shearing stress (force which occurs in the horizontal direction and which occurs at the interface between the separator and the electrode) to occur via the particles that deformed the separator (porous film) in the thicknesswise direction. Furthermore, the shearing stress is transferred, via a resin inside the separator, to an interface between the separator and an electrode, which interface is on a side opposite the side facing the expanded electrode.

Therefore, a critical load distance calculated by the scratch test serves as (a) an indicator of how easily a surface layer of a porous film (separator) is plastically-deformed and (b) an indicator of how easily shearing stress is transferred to a surface opposite a measured surface. If a critical load distance is long, then it indicates that (a′) a surface layer of a porous film to be measured is unlikely be plastically-deformed and (b′) shearing stress is unlikely (difficult) to be transferred to a surface opposite a measured surface of the porous film to be measured.

Hence, a porous film, which has a value beyond 0.54 as represented by the Formula (1), shows that there exists large anisotropy between a critical load distance in a traverse direction and a critical load distance in a machine direction. In a case of a nonaqueous electrolyte secondary battery in which a porous film having large anisotropy is included as a separator or as a member of a separator, a plastic deformation of a surface layer of the separator (porous film), which plastic deformation occurs as a result of charge/discharge, occurs predominantly in a certain direction. Since transferability of surface stress to a surface opposite a surface facing an expanded electrode varies between a traverse direction and a machine direction, a wrinkle and a gap which occur at an interface between the separator and the electrode occurs predominantly in a certain direction. This causes a decrease in surface-wise uniformity in distance between the electrodes, and therefore causes a reduction in rate characteristic maintaining ratio of the nonaqueous electrolyte secondary battery after a charge-discharge cycle.

The following description will discuss a nonaqueous electrolyte secondary battery configured so that a laminated body is wound. This configuration is one aspect of a laminated body including (i) electrodes and (ii) a separator which is a porous film or which includes a porous film as a member thereof. In the nonaqueous electrolyte secondary battery configured so that the laminated body is wound, the laminated body is wound while tensile force is being applied in a machine direction to the separator. This causes an increase in smoothness in the machine direction of the porous film, and causes internal stress to be inwardly applied to an axis extending in a traverse direction. Therefore, according to the nonaqueous electrolyte secondary battery configured so that the laminated body is wound, (i) a critical load distance in the machine direction during actual operation is longer than a critical load distance, in a machine direction, which is calculated by the scratch test and (ii) a critical load distance in the traverse direction is shorter than a critical load distance, in a traverse direction, which is calculated in the scratch test. Therefore, in a case where a critical load distance in the traverse direction and a critical load distance in the machine direction are similar (i.e. highly isotropic), specifically, in a case where a porous film having a value of equal to or greater than −0.54 and less than 0.00 as represented by the Formula (2) is used as a separator or as a member of a separator in a nonaqueous electrolyte secondary battery configured so that a laminated body is wound, the critical load distance in the machine direction increases, so that the critical load distance in the traverse direction decreases. Therefore, in actual operation, a wrinkle and a gap in the traverse direction occur predominantly among the following wrinkles and gaps: (i) the wrinkle and the gap which occur at an interface between the separator and the electrode and which are caused by a plastic deformation of the surface layer of the separator (porous film) in the traverse direction and (ii) a wrinkle and a gap which occur at the interface between the separator and the electrode and which are caused by a difference between in transferability of surface stress to a surface opposite the surface facing the electrode expanded in the machine direction. This causes a decrease in surface-wise uniformity in distance between the electrodes. Meanwhile, in a case where a nonaqueous electrolyte secondary battery configured so that the laminated body is wound has highly anisotropic critical load distances in a traverse direction and in the machine direction, specifically, in a case where the value obtained by the Formula (1) is beyond 0.54, the occurrences of the following wrinkles and gaps in a direction in which a critical load distance is longer increase for a reason similar to the reason described above; (i) a wrinkle and a gap which are caused by a plastic deformation of a surface layer of the separator (porous film) and (ii) a wrinkle and a gap which occur at an interface between the separator and the expanded electrode and which are caused by a difference between a traverse direction and a machine direction in terms of transferability of surface stress to a surface opposite the surface facing the expanded electrode. This causes a reduction in a rate characteristic maintaining ratio of the nonaqueous electrolyte secondary battery after a charge-discharge cycle. Therefore, the value obtained by the Formula (2) is preferably in a range of 0.00 to 0.54 in view of the fact that, with such a value, a porous film can be suitably used for a nonaqueous electrolyte secondary battery configured so that the laminated body is wound.

Note that a critical load distance in a traverse direction and a critical load distance in a machine direction are considered to be greatly affected by the following structure factors of a porous film:
(i) How polymers in a resin are aligned in the machine direction of the porous film
(ii) How polymers in a resin are aligned in the traverse direction of the porous film
(iii) How the polymers in the resin aligned in the machine direction and the polymers in the resin aligned in the traverse direction are in contact with each other with respect to a thicknesswise direction of the porous film

Therefore, respective values obtained by the Formula (1) and the Formula (2) can be controlled by, for example, controlling the above structure factors (i) through (iii) through adjusting the following conditions under which a porous film production method (described later) is carried out:
(1) Circumferential velocity [m/min] of a rolling mill roll
(2) Ratio of stretch temperature to stretch magnification [° C./%]

Specifically, the circumferential velocity of the rolling mill roll and the ratio of the stretch temperature to the stretch magnification during stretching are adjusted so that the circumferential velocity of the rolling mill roll, the stretch temperature during stretching, and the stretch magnification satisfy the relationship of a Formula (3) below, provided that production of the porous film is not impaired. This allows the respective values obtained by the Formula (1) and the Formula (2) to be each controlled in a range of 0.00 to 0.54.

Y≧−2.3*X+22.2 (3)

where (i) X represents the circumferential velocity of the rolling mill roll and (ii) Y represents the ratio of the stretch temperature to the stretch magnification during stretching in the traverse direction.

Meanwhile, in a case where the ratio is set so as to fall outside the range satisfying the relationship of the above Formula (3), (i) the alignment of the polymers in the resin in the machine direction of the porous film or the alignment of the polymers in the resin in the traverse direction of the porous film is promoted and/or (ii) connectivity, in a thicknesswise direction of the porous film, of the polymers in the resin aligned in the machine direction or of the polymers in the resin aligned in the traverse direction is promoted. This causes the anisotropy of the porous film as represented by the Formula (1) to be large, so that it is not possible to control the value obtained by the Formula (1) to fall within the range of 0.00 to 0.54. For example, in a case where the circumferential velocity of the rolling mill roll is adjusted to 2.5 m/min and where the ratio of the stretch temperature to the stretch magnification is adjusted to less than 16.5° C./%, (i) the alignment of the polymers in the resin in the traverse direction of the porous film increases and (ii) the thicknesswise direction-wise connectivity of the polymers in the resin aligned in the traverse direction increases. This causes a critical load distance in the traverse direction to he short, so that the anisotropy as represented by the Formula (1) to be equal to or greater than 0.54.

The stretch temperature is preferably 90° C. to 120° C., and more preferably 100° C. to 110° C. The stretch magnification is preferably 600% to 800%, and more preferably 620% to 700%.

In a case where a porous layer is formed on a porous film so that a nonaqueous electrolyte secondary battery laminated separator is produced, it is preferable to carry out a hydrophilization treatment before the porous layer is formed, that is, before a coating solution described later is applied. In a case where the porous film is subjected to a hydrophilization treatment, applicability of the coating solution is enhanced. This allows a more uniform porous layer to be formed. A hydrophilization treatment is effective in a case where a solvent (dispersion medium) contained in a coating solution has a high water content. Specific examples of the hydrophilization treatment encompass publicly known treatments such as (i) a chemical treatment in which an acid, an alkali, or the like is used, (ii) a corona treatment, and (iii) a plasma treatment. Among these hydrophilization treatments, a corona treatment is more preferable because a corona treatment allows a porous film to be hydrophilized in a relatively short period of time and causes only a part in the vicinity of a surface of the porous film to be hydrophilized, so that the inside of the porous film remains unchanged in quality.

<Method of Producing Porous Film>

A method of producing the porous film is not limited to any particular one. Examples of the method encompass a method in which (i) a plasticizer is added to a resin such as polyolefin, (ii) a resultant mixture is formed into a film, and (iii) the plasticizer is removed with the use of a proper solvent.

Specifically, in a case where, for example, a porous film is produced with the use of a polyolefin resin including ultra-high molecular weight polyethylene and low molecular weight poly olefin having a weight-average molecular weight of equal to or less than 10,000, the porous film is, in view of production costs, preferably produced by the following method.

A method of obtaining a porous film, including the steps of:
(1) kneading 100 parts by weight of ultra-high molecular weight polyethylene, 5 parts by weight to 200 parts by weight of low molecular weight poly olefin having a weight-average molecular weight of equal to or less than 10,000, and 100 parts by weight to 400 parts by weight of a pore forming agent such as a calcium carbonate or a plasticizer, so that a polyolefin resin composition is obtained;
(2) rolling the polyolefin resin composition, so as to form a rolled sheet;
(3) removing the pore forming agent from the rolled sheet;
(4) stretching the rolled sheet from which the pore forming agent has been removed in the step (3), so as to obtain a stretched sheet; and
(5) heat fixing the stretched sheet at a heat fixing temperature of 100° C. to 150° C.
   Alternatively, a method of obtaining a porous film, including the steps of:
(1) kneading 100 parts by weight of ultra-high molecular weight polyethylene, 5 parts by weight to 200 parts by weight of low molecular weight polyolefin having a weight-average molecular weight of equal to or less than 10,000, and 100 parts by weight to 400 parts by weight of a pore forming agent such as a calcium carbonate or a plasticizer, so that a polyolefin resin composition is obtained;
(2) rolling the polyolefin resin composition, so as to form a rolled sheet;
(3′) stretching the rolled sheet, so as to obtain a stretched sheet;
(4′) removing the pore forming agent from the stretched sheet; and
(5′) heat fixing the stretched sheet, which has been thus obtained in the step (4′), at a heat fixing temperature of 10° C. to 150° C.

A porous film satisfying the Formulas (1) and (2) can be produced by adjusting (i) the circumferential velocity of the rolling mill roll to be used in the rolling process in the step (2) and/or (ii) the ratio of the stretch temperature to the stretch magnification during stretching in the step (4) or in the step (3′).

Specifically, it is preferable to adjust the circumferential velocity of the rolling mill roll and the ratio of the stretch temperature to the stretch magnification during stretching so as to satisfy the relationship of the following Formula (3):

Y≧−2.3×X+22.2 (3)

where (i) X represents the circumferential velocity of the rolling mill roll and (ii) Y represents the ratio of the stretch temperature to the stretch magnification during stretching in the traverse direction.

Alternatively, a porous film satisfying the Formulas (1) and (2) can also be produced by (i) cooling the stretched sheet after the heat fixing and then (ii) repeatedly carrying out the stretching and the heat fixing. Specifically, a porous film satisfying the Formulas (1) and (2) can also be produced by, after the heat fixing, further stretching the stretched film in a machine direction and in a traverse direction, preferably in a machine direction.

Alternatively, a porous film satisfying the Formulas (1) and (2) can be produced by properly combining, as needed, other conditions such as a composition of the porous film and the heat fixing temperature.

On the porous film, a publicly known porous layer including, for example, an adhesive layer, a heat-resistant layer, and/or a protection layer can be provided. A separator including a nonaqueous electrolyte secondary battery separator and a porous layer is herein referred to as a nonaqueous electrolyte secondary battery laminated separator (hereinafter referred to also as “laminated separator”). In a case where a porous layer is formed on a porous film so that a nonaqueous electrolyte secondary battery laminated separator is produced, it is preferable to subject the porous film to a hydrophilization treatment before the porous layer is formed, that is, before a coating solution described later is applied. In a case where the porous film is subjected to a hydrophilization treatment, applicability of the coating solution is enhanced. This allows a more uniform porous layer to be formed. A hydrophilization treatment is effective in a case where a solvent (dispersion medium) contained in a coating solution has a high water content. Specific examples of the hydrophilization treatment encompass publicly known treatments such as (i) a chemical treatment in which an acid, an alkali, or the like is used, (ii) a corona treatment, and (iii) a plasma treatment. Among these hydrophilization treatments, a corona treatment is more preferable because a corona treatment allows a porous film to be hydrophilized in a relatively short period of time and causes only a part in the vicinity of a surface of the porous film to be hydrophilized, so that the inside of the porous film remains unchanged in quality.

<Porous Layer>

The porous layer in accordance with an embodiment of the present invention is ordinarily a resin layer containing a resin, and can contain fine particles. The porous layer in accordance with an embodiment of the present invention is preferably a heat-resistant layer or an adhesive layer to be laminated on one surface or both surfaces of the porous film. The porous layer preferably contains a resin that (i) is insoluble in the electrolyte solution of the battery and that (ii) is electrochemically stable when the battery is in normal use. In a case where the porous layer is laminated on one surface of the porous film, the porous layer is preferably on that surface of the porous film which faces the cathode of a nonaqueous electrolyte secondary battery to be produced, more preferably on that surface of the porous film which comes into contact with the cathode.

Specific examples of the resin encompass polyolefins such as polyethylene, polypropylene, polybutene, and ethylene-propylene copolymer; fluorine-containing resins such as a homopolymer of vinylidene fluoride (polyvinylidene fluoride), a copolymer of vinylidene fluoride (such as a vinylidene fluoride-hexafluoropropylene copolymer and a vinylidene fluoride-hexafluoropropylene-tetrafluoroethylene copolymer), a copolymer of tetrafluoroethylene (such as ethylene-tetrafluoroethylene copolymer), and any of these fluorine-containing resins which is a fluorine-containing rubber having a glass transition temperature of equal to or less than 23° C.; aromatic polyamides; fully aromatic polyamides (aramid resins); rubbers such as styrene-butadiene copolymer and a hydride thereof, methacrylic acid ester copolymer, acrylonitrile-acrylic acid ester copolymer, styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, polyetheramide., and polyester; and water-soluble polymers such as polyvinyl alcohol, polyethyleneglycol, cellulose ether, sodium alginate, polyacrylic acid, polyacrylamide, and polymethacrylic acid.

Suitable examples of the resin to be contained in the porous layer in accordance with an embodiment of the present invention encompass a water-insoluble polymer. In other words, the porous layer in accordance with an embodiment of the present invention is preferably produced with the use of an emulsion or a dispersion obtained by dispersing a water-insoluble polymer (e.g. acrylate resin) in an aqueous solvent, so that the porous layer in accordance with an embodiment of the present invention contains the water-insoluble polymer as the resin.

Note that a water-insoluble polymer is a polymer that does not become dissolved in an aqueous solvent but becomes particles so as to be dispersed in the aqueous solvent. The definition of a water-insoluble polymer is not clear. According to PCT International Publication No. WO2013/031690, for example, “a polymer being water-insoluble” is defined such that in a case where 0.5 g of the polymer is dissolved in 100 g of water at 25° C., an insoluble content is equal to or greater than 90 weight %. Meanwhile, “a polymer being water-soluble” is defined such that in a case where 0.5 g of the polymer is dissolved in 100 g of water at 25° C., an insoluble content is less than 0.5 weight %. A shape of each of the particles of the water-insoluble polymer is not limited to any particular one, but is preferably a spherical shape.

The water-insoluble polymer, which is polymer particles, is produced by, for example, polymerizing, in an aqueous solvent, a monomer composition containing a monomer (described later).

Examples of the monomer constituting the water-insoluble polymer encompass styrene, vinyl ketone, acrylonitrile, methyl methacrylate, ethyl methacrylate, glycidyl methacrylate, glycidyl acrylate, methyl acrylate, ethyl acrylate, and butyl acrylate.

The polymer can contain, in addition to a homopolymer of monomers, a copolymer of two or more types of monomers. Examples of the polymer encompass fluorine-containing resins such as polyvinylidene fluoride, a copolymer of vinylidene fluoride (such as a vinylidene fluoride-hexafluoropropylene copolymer and a vinylidene fluoride-hexafluoropropylene-tetrafluoroethylene copolymer), and a copolymer of tetrafluoroethylene (such as an ethylene-tetrafluoroethylene copolymer); a melamine resin; a urea resin; polyethylene; polypropylene; polymethyl acrylate, polymethyl methacrylate, and poly butyl acrylate.

The aqueous solvent is not limited to any particular one, provided that the aqueous solvent contains water as a main component and that the water-insoluble polymer particles can be dispersed in the aqueous solvent. The aqueous solvent can contain any amount of organic solvent, examples of which encompass methanol, ethanol, isopropyl alcohol, acetone, tetrahydrofuran, acetonitrile, and N-methylpyrrolidone, any of which can be mixed with water at any ratio. It is also possible to add, to the aqueous solvent, a dispersing agent and/or a surfactant. Examples of the dispersing agent encompass sodium dodecylbenzene sulfonate. Examples of the surfactant encompass: a poly acrylic acid; and a sodium salt of carboxymethyl cellulose. In a case where these additives such as the solvent and the surfactant are to be used, the additives can be used individually, or a mixture of two or more of the additives can be used. A ratio of a weight of the organic solvent to water is 0.1 weight % to 99 weight %, preferably 0.5 weight % to 80 weight %, and more preferably 1 weight % to 50 weight %.

Note that the resin to be contained in the porous layer in accordance with an embodiment of the present invention can be a resin of a single type or a mixture of two or more types of resins.

Specific examples of the aromatic poly amides encompass poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), paraphenylene terephthalamide/2,6-dichloroparaphenylene terephthalamide copolymer, and methaphenylene terephthalamide/2,6-dichloroparaphenylene terephthalamide copolymer. Among these, poly(paraphenylene terephthalamide) is preferable.

Among the above resins, more preferable examples encompass a polyolefin, a fluorine-containing resin, an aromatic polyamide, a water-soluble polymer, and a water-insoluble polymer in the form of particles dispersed in an aqueous solvent. In particular, in a case where the porous layer is provided so as to face the cathode, still more preferable examples encompass a fluorine-containing resin and a fluorine-containing rubber, and particularly preferable examples encompass (i) a copolymer of vinylidene fluoride and at least one monomer selected from the group consisting of hexafluoropropylene, tetrafluoroethylene, trifluoro ethylene, trichloroethylene, and vinyl fluoride (that is, a vinylidene fluoride-hexafluoropropylene copolymer or the like) and (ii) a homopolymer of vinylidene fluoride (that is, polyvinylidene fluoride), because these resins facilitate maintaining various performance capabilities of the nonaqueous electrolyte secondary battery such as the rate characteristic and resistance characteristic (solution resistance) even in a case where the battery suffers from acidic deterioration while operating. A water-soluble polymer and a water-insoluble polymer in the form of particles dispersed in an aqueous solvent can each allow water to be used as a solvent to form a porous layer, and are therefore more preferable in view of a process and an environmental impact. Cellulose ether and sodium alginate are still more preferable as the water-soluble polymer and cellulose ether is particularly preferable.

Specific examples of the cellulose ether encompass carboxymethyl cellulose (CMC), hydroxyethyl cellulose (HEC), carboxy ethyl cellulose, methyl cellulose, ethyl cellulose, cyan ethyl cellulose, and oxyethyl cellulose. Among these, CMC and HEC, which deteriorate less after being used for a long time and have excellent chemical stability, are more preferable, and CMC is particularly preferable.

In view of adhesiveness between fine particles (e.g. between inorganic fillers) in a case where the fine particles are contained in the porous layer in accordance with an embodiment of the present invention, preferable examples of the water-insoluble polymer in the form of particles dispersed in an aqueous solvent encompass (i) a homopolymer of acrylate monomers such as methyl methacrylate, ethyl methacrylate, glycidyl methacrylate, glycidyl acrylate, methyl acrylate, ethyl acrylate, and butyl acrylate and (ii) a copolymer of two or more types of monomers.

Fine particles herein refers to organic fine particles or inorganic fine particles generally referred to as a filler. Therefore, the above resins each have a function as a binder resin for binding (i) fine particles together and (ii) fine particles and the porous film. The fine particles are preferably electrically insulating fine particles.

Specific examples of the organic fine particles contained in the porous layer in accordance with an embodiment of the present invention encompass (i) a homopolymer of a monomer such as styrene, vinyl ketone, acrylonitrile, methyl methacrylate, ethyl methacrylate, glycidyl methacrylate, glycidyl acrylate, or methyl acrylate, and (ii) a copolymer of two or more of such monomers; fluorine-containing resins such as polytetrafluoroethylene; ethylene tetrafluoride-propylene hexafluoride copolymer, tetrafluoroethylene-ethylene copolymers and polyvinylidene fluoride; melamine resin; urea resin; polyethylene; polypropylene; and polyacrylic acid and polymethacrylic acid. These organic fine particles are electrically insulating fine particles.

Specific examples of the inorganic fine particles contained in the porous layer in accordance with an embodiment of the present invention encompass fillers made of inorganic matters such as calcium carbonate, talc, clay, kaolin, silica, hydrotalcite, diatomaceous earth, magnesium carbonate, barium carbonate, calcium sulfate, magnesium sulfate, barium, sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. These inorganic fine particles are electrically insulating fine particles. The porous layer may contain (i) only one kind of the fine particles or (ii) two or more kinds of the fine particles in combination.

Among the above fine particles, fine particles made of inorganic matter is suitable. Fine particles made of an inorganic oxide such as silica, calcium oxide, magnesium oxide, titanium oxide, alumina, mica, zeolite, aluminum hydroxide, or boehmite are preferable. Fine particles made of at least one kind selected from the group consisting of silica, magnesium oxide, titanium oxide, aluminum hydroxide, boehmite, and alumina are more preferable. Fine particles made of alumina are particularly preferable. While alumina has many crystal forms such as α-alumina, β-alumina, γ-alumina, and θ-alumina, any of the crystal forms can he used suitably. Among the above crystal forms, α-alumina is the most preferable because it is particularly high in thermal stability and chemical stability.

The fine particles have a shape that varies depending on, for example, (i) the method of producing the organic matter or inorganic matter as a raw material and (ii) the condition under which the fine particles are dispersed when the coating solution for forming a porous layer is prepared. The fine particles may have any shape such as a spherical shape, an oblong shape, a rectangular shape, a gourd shape, or an indefinite, irregular shape.

In a case where the porous layer contains fine particles, fine particle content is preferably 1% by volume to 99% by volume, and more preferably 5% by volume to 95% by volume with respect to 100% by volume of the porous layer. In a case where the fine particle content falls within these ranges, it is less likely for a void, which is formed when fine particles come into contact with each other, to be blocked by a resin or the like. This makes it possible to achieve sufficient ion permeability and a proper weight per unit area of the porous film.

The fine particles to be used can be a combination of two or more kinds which differ from each other in particle diameter and/or specific surface area.

A fine particle content of the porous layer is preferably 1% by volume to 99% by volume, and more preferably 5% by volume to 95% by volume with respect to 100% by volume of the porous layer. In a case where the fine particle content falls within these ranges, it is less likely for a void, which is formed when fine particles come into contact with each other, to be blocked by a resin or the like. This makes it possible to achieve sufficient ion permeability and a proper weight per unit area of the porous film.

A thickness of the porous layer in accordance with an embodiment of the present invention can be decided as appropriate in view of a thickness of the laminated body which is the nonaqueous electrolyte secondary battery laminated separator. Note, however, that in a case where the laminated body is formed by laminating the porous layer on one surface or both surfaces of the porous film serving as a base material, the thickness of the porous layer is preferably 0.5 μm to 15 μm (per surface of the porous film), and more preferably 2 μm to 10 μm (per surface of the porous film).

If the thickness of the porous layer is less than 1 μm, then the laminated body, which is used as a nonaqueous electrolyte secondary battery laminated separator, makes it impossible to sufficiently prevent an internal short circuit of the battery, which internal short circuit is caused by breakage or the like of the battery. In addition, an amount of electrolyte solution to be retained by the porous film decreases. In contrast, if a total thickness of both surfaces of the porous layer is above 30 μm, then the laminated body, which is used as a nonaqueous electrolyte secondary battery laminated separator, causes an increase in resistance to permeation of lithium ions all over the separator. This causes a cathode to deteriorate in a case where a charge-discharge cycle is repeated. Consequently, a rate characteristic and/or a cycle characteristic deteriorate(s). In addition, since a distance between the cathode and an anode becomes longer, the nonaqueous electrolyte secondary battery becomes large in size.

In a case where porous layers are laminated on respective both surfaces of the porous film, physical properties of the porous layer described below refer to at least physical properties of a porous layer which is laminated on a surface of the porous film, which surface faces a cathode included in a nonaqueous electrolyte secondary battery.

The weight per unit area of the porous layer (per surface of the porous film) can be decided as appropriate in view of strength, thickness, weight, and handleability of the laminated body. Note, however, that the weight per unit area of the porous layer is preferably 1 g/m² to 20 g/m², and more preferably 4 g/m² to 10 g/m² on an ordinary basis so that the battery can have high energy density per unit weight and high energy density per unit volume in a case where the laminated body is used as a nonaqueous electrolyte secondary battery laminated separator. If the weight per unit area of the porous layer is above these ranges, then the nonaqueous electrolyte secondary battery becomes heavy in weight in a case where the laminated body is used as a nonaqueous electrolyte secondary battery laminated separator.

A volume per square meter of a porous layer constituent component contained in the porous layer (per surface of the porous film) is preferably 0.5 cm³ to 20 cm³, more preferably 1 cm³ to 10 cm³, and still more preferably 2 cm³ to 7 cm³. In other words, a component volume per unit area of the porous layer (per surface of the porous film) is preferably 0.5 cm³/m² to 20 cm³/m², more preferably 1 cm³/m² to 10 cm³/m², and still more preferably 2 cm³/m² to 7 cm³/m². If the component volume per unit area of the porous layer is below 0.5 cm³/m², then the laminated body, which is used as a nonaqueous electrolyte secondary battery laminated separator, makes it impossible to sufficiently prevent an internal short circuit of the battery, which internal short circuit is caused by breakage or the like of the battery. If the component volume per unit area of the porous layer is above 20 cm³/m², then the laminated body, which is used as a nonaqueous electrolyte secondary battery laminated separator, causes an increase in resistance to permeation of lithium ions all over the separator. This causes a cathode to deteriorate in a case where a charge-discharge cycle is repeated. Consequently, a rate characteristic and/or a cycle characteristic deteriorate(s).

For the purpose of obtaining sufficient ion permeability, a porosity of the porous layer is preferably 20% by volume to 90% by volume, and more preferably 30% by volume to 80% by volume. In order for the porous layer and a nonaqueous electrolyte secondary battery laminated separator including the porous layer to obtain sufficient ion permeability, a pore size of each of the pores of the porous layer is preferably equal to or less than 3 μm, and more preferably equal to or less than 1 μm.

<Laminated Body>

A laminated body, which is a nonaqueous electrolyte secondary battery laminated separator in accordance with an embodiment of the present invention, is configured by laminating the porous layer on one surface or both surfaces of the porous film.

The thickness of the laminated body in accordance with an embodiment of the present invention is preferably 5.5 μm to 45 μm, and more preferably 6 μm to 25 μm.

Air permeability of the laminated body in accordance with an embodiment of the present invention in terms of Gurley values is preferably 30 sec/100 mL to 1000 sec/100 mL, and more preferably 50 sec/100 mL to 800 sec/100 mL. In a case where the air permeability of the laminated body falls within the these ranges, the laminated body, which is used as a nonaqueous electrolyte secondary battery laminated separator, can have sufficient ion permeability. If the air permeability is above these ranges, then it means that the laminated body has a high porosity and that a laminated structure is therefore rough. This poses a risk that strength of the laminated body may decrease, so that shape stability particularly at a high, temperature may be insufficient. In contrast, if the air permeability is below these ranges, then the laminated body, which is used as a nonaqueous electrolyte secondary battery laminated separator, may not have sufficient ion permeability. This may cause deterioration of the battery characteristic of the nonaqueous electrolyte secondary battery.

As necessary, the laminated body in accordance with an embodiment of the present invention can include, in addition to the porous film and the porous layer, a publicly known porous film(s) such as a heat-resistant layer, an adhesive layer, and/or a protection layer, provided that the object of an embodiment of the present invention is attained.

<Porous Layer Production Method, Laminated Body Production Method>

Examples of a method of producing each of the porous layer in accordance with an embodiment of the present invention and the laminated body in accordance with an embodiment of the present invention encompass a method in which (i) a surface of the porous film is coated with a coating solution described later and then (ii) the coating solution is dried so as to precipitate the porous layer.

A coating solution used in the method of producing the porous layer in accordance with an embodiment of the present invention can ordinarily be prepared by (i) dissolving, in a solvent, a resin which will be contained in the porous layer in accordance with an embodiment of the present invention and (ii) dispersing, into the solvent, fine particles which will be contained in the porous layer in accordance with an embodiment of the present invention.

The solvent (disperse medium) can be any solvent which (i) does not adversely influence the porous film, (ii) allows the resin to be dissolved uniformly and stably, and (iii) allows the fine particles to be dispersed uniformly and stably. Specific examples of the solvent (disperse medium) encompass, but are not particularly limited to: water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide. The present embodiment may use only one kind of solvent (disperse medium) or two or more kinds of solvents in combination.

The coating solution may be formed by any method provided that the coating solution can meet conditions such as a resin solid content (resin concentration) and a fine particle amount necessary for obtaining a desired porous layer. Specific examples of a method of forming the coating solution encompass a mechanical stirring method, an ultrasonic dispersion method, a high-pressure dispersion method, a media dispersion method, and the like. Further, for example, the fine particles may be dispersed in the solvent (dispersion medium) by use of a conventionally known disperser such as a three-one motor, a homogenizer, a media disperser, or a pressure disperser. In addition, the coating solution can also be prepared simultaneously with wet grinding of fine particles in a case where a liquid in which a resin is dissolved or swelled, or a liquid in which a resin is emulsified is supplied to a wet grinding device during wet grinding carried out to obtain fine particles having a desired average particle size. That is, wet grinding of the fine particles and preparation of the coating solution may be simultaneously carried out in a single step. Further, the coating solution may contain, as a component other than the resin and the fine particles, an additive such as a disperser, a plasticizer, a surfactant, or a pH adjuster, provided that the additive does not impair the object of an embodiment of the present invention. Note that the additive may be contained in an amount that does not impair the object of an embodiment of the present invention.

The method of coating the porous film with the coating solution, that is, the method of forming a porous layer on a surface of a porous film that has been subjected to a hydrophilization treatment as necessary, is not limited to any particular one. In a case where porous layers are deposited on respective surfaces of the porous film, (i) it is possible to employ a sequential deposition method in which a porous layer is formed on one surface of the porous film and then another porous layer is formed on the other surface, or (ii) it is possible to employ a simultaneous deposition method in which porous layers are simultaneously formed on respective surfaces of the porous film. Examples of the method of forming the porous layer, that is, the method of producing the laminated body encompass: a method in which a surface of a porous film is directly coated with a coating solution, and then a solvent (dispersion medium) is removed; a method in which appropriate support is coated with a coating solution, a solvent (dispersion medium) is removed so as to form a porous layer, and then the porous layer and a porous film are bonded together by pressure, and then the support is peeled off; a method in which an appropriate support, is coated with a coating solution, then a porous film is bonded to the coated surface by pressure, then the support is peeled off, and then the solvent (dispersion medium) is removed; and a method in which a porous film is soaked in a coating solution so as to carry out dip coating, and then a solvent (dispersion medium) is removed. A thickness of the porous layer can be controlled by adjusting a thickness of a coating film which is in a wet state (Wet) after coating, a weight ratio between the resin and the fine particles, a solid content concentration (i.e., a sum of a resin concentration and a fine particle concentration) of the coating solution, and the like. Note that examples of the support encompass a resin film, a metal belt, and a drum.

The method of coating the porous film or the support with a coating solution is not limited to any particular one, provided that the method can achieve a necessary weight per unit area and a necessary coating area. The method of applying the coating solution can be a conventionally known method. Specific examples of applying the coating solution encompass a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray coating method, and the like.

The solvent (disperse medium) is removed typically by a drying method. Examples of the drying method encompass natural drying, air-blowing drying, heat drying, and drying under reduced pressure. However, the solvent can be removed by any method that allows the solvent (disperse medium) to be removed sufficiently. The coating solution can be dried after the solvent (disperse medium) contained in the coating solution is replaced with another solvent. The solvent (disperse medium) can be replaced with another solvent for removal by, for example, a method of (i) preparing another solvent (hereinafter referred to as “solvent X”) that dissolves the solvent (disperse medium) contained in the coating solution and that does not dissolve the resin contained in the coating solution, (ii) immersing the porous film or support, to which the coating solution has been applied and on which a coating film has been formed, into the solvent X to replace the solvent (disperse medium) in the coating film on the porous film or support with the solvent X, and (iii) evaporating the solvent X. This method allows the solvent (disperse medium) to be removed efficiently from the coating solution. In a case where the coating film, formed on the porous film or support by applying the coating solution thereto, is heated when removing the solvent (disperse medium) or solvent X from the coating film, the coating film is desirably heated at a temperature that does not decrease the air permeability of the porous film, specifically within a range of 10° C. to 120° C., preferably within a range of 20° C. to 80° C., to prevent pores in the porous film from contracting to decrease the air permeability of the porous film.

It is preferable to remove the solvent (dispersion medium) by, in particular, a method in which a base material is coated with a coating solution and then the coating solution is dried so as to form a porous layer. With the configuration, it is possible to achieve a porous layer in which porosity varies by a smaller degree of variation and which hardly has a wrinkle.

The above drying can be carried out with the use of an ordinary drying device.

### Embodiment 3: Nonaqueous Electrolyte Secondary Battery Member, Embodiment 4: Nonaqueous Electrolyte Secondary Battery

A nonaqueous electrolyte secondary battery member in accordance with Embodiment 3 of the present invention includes: a cathode; the nonaqueous electrolyte secondary battery separator in accordance with Embodiment 1 of the present invention or the nonaqueous electrolyte secondary battery laminated separator in accordance with Embodiment 2 of the present invention; and an anode, the cathode, the separator, and the anode being arranged in this order. A nonaqueous electrolyte secondary battery in accordance with Embodiment 4 of the present invention includes the nonaqueous electrolyte secondary battery separator in accordance with Embodiment 1 of the present invention or the nonaqueous electrolyte secondary battery laminated separator in accordance with Embodiment 2 of the present invention. The nonaqueous electrolyte secondary battery in accordance with Embodiment 4 preferably includes the nonaqueous electrolyte secondary battery member in accordance with Embodiment 3 of the present invention. Note that the nonaqueous electrolyte secondary battery in accordance with Embodiment 4 of the present invention further includes a nonaqueous electrolyte solution.

[Nonaqueous Electrolyte Solution]

The nonaqueous electrolyte solution in accordance with an embodiment of the present invention is a nonaqueous electrolyte solution generally used for a nonaqueous electrolyte secondary battery. Examples of the nonaqueous electrolyte solution encompass, but are not particularly limited to, a nonaqueous electrolyte solution prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. The present embodiment may use (i) only one kind of the above lithium salts or (ii) two or more kinds of the above lithium salts in combination. The present embodiment preferably uses, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Specific examples of the organic solvent in the nonaqueous electrolyte solution in accordance with an embodiment of the present invention encompass carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into the organic solvent. The present embodiment may use (i) only one kind of the above organic solvents or (ii) two or more kinds of the above organic solvents in combination. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is preferably a mixed solvent of ethylene carbonate, dimethyl carbonate, and ethyl methyl carbonate because such a mixed solvent allows a wider operating temperature range, and is not easily decomposed even in a case where the present embodiment uses, as an anode active material, a graphite material such as natural graphite or artificial graphite.

[Cathode]

The cathode is ordinarily a sheet-shaped cathode including (i) a cathode mix containing a cathode active material, an electric ally conductive material, and a binding agent and (ii) a cathode current collector supporting the cathode mix thereon.

The cathode active material is, for example, a material capable of being doped and dedoped with lithium ions. Specific examples of such a material encompass a lithium complex oxide containing at least one transition metal such as V, Mn, Fe, Co, or Ni. Among such lithium complex oxides, (i) a lithium complex oxide having an α-NaFeO₂ structure such as lithium nickelate and lithium cobaltate and (ii) a lithium complex oxide having a spinel structure such as lithium manganese spinel are preferable because such lithium complex oxides have a high average discharge potential. The lithium complex oxide containing the at least one transition metal may further contain any of various metallic elements, and is more preferably complex lithium nickelate.

Further, the complex lithium nickelate even more preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metallic element and the number of moles of Ni in the lithium nickelate. This is because such a complex lithium nickelate allows an excellent cycle characteristic in a case where it is used in a high-capacity battery. The active material particularly preferably contains Al or Mn, and contains Ni at a proportion of equal to or greater than 85%, further preferably equal to or greater than 90%. This is because a nonaqueous electrolyte secondary battery including a cathode containing such an active material has an excellent cycle characteristic in a case where the nonaqueous electrolyte secondary battery has a high capacity.

Examples of the electrically conductive material encompass carbonaceous materials such as natural graphite, artificial graphite, cokes, carbon black, pyrolytic carbons, carbon fiber, and a fired product of an organic polymer compound. It is possible to use (i) only one kind of the above electrically conductive materials or (ii) two or more kinds of the above electrically conductive materials in combination, for example, a mixture of artificial graphite and carbon black.

Examples of the binding agent encompass thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene, as well as acrylic resin and styrene-butadiene-rubber. The binding agent functions also as a thickening agent.

The cathode mix may be prepared by, for example, a method of applying pressure to the cathode active material, the electrically conductive material, and the binding agent on the cathode current collector or a method of using an appropriate organic solvent so that the cathode active material, the electrically conductive material, and the binding agent are in a paste form.

The cathode current collector is, for example, an electric conductor such as Al, Ni, and stainless steel, among which Al is preferable because Al is easily processed into a thin film and is inexpensive.

The sheet-shaped cathode may be produced, that is, the cathode mix may be supported by the cathode current collector, by, for example, a method of applying pressure to the cathode active material, the electrically conductive material, and the binding agent on the cathode current collector to form a cathode mix thereon or a method of (i) using an appropriate organic solvent so that the cathode active material, the electrically conductive material, and the binding agent are in a paste form to provide a cathode mix, (ii) applying the cathode mix to the cathode current collector, (iii) drying the applied cathode mix to prepare a sheet-shaped cathode mix, and (iv) applying pressure to the sheet-shaped cathode mix so that the sheet-shaped cathode mix is firmly fixed to the cathode current collector.

[Anode]

The anode is ordinarily a sheet-shaped anode including (i) an anode mix containing an anode active material and (ii) an anode current collector supporting the anode mix thereon. The sheet-shaped anode preferably contains the above-described electrically conductive material and binding agent.

The anode active material is, for example, (i) a material capable of being doped and dedoped with lithium ions, (ii) a lithium metal, or (iii) a lithium alloy. Specific examples of the material encompass carbonaceous materials such as natural graphite, artificial graphite, cokes, carbon black, pyrolytic carbons, carbon fiber, and a fired product of an organic polymer compound; chalcogen compounds such as an oxide and a sulfide that are doped and dedoped with lithium ions at an electric potential lower than that for the cathode; metals that can be alloyed with an alkali metal such as aluminum (Al), lead (Pb), tin (Sn), bismuth (Bi), and silicon (Si); cubic-crystal intermetallic compounds (for example, AlSb, Mg₂Si, and NiSi₂) of which an alkali metal is insertable into the lattice; and a lithium nitrogen compound such as Li₃₋ₓMₓN (where M is a transition metal). Among the above anode active materials, a carbonaceous material containing a graphite material such as natural graphite or artificial graphite as a main component is preferable because such a carbonaceous material has high electric potential flatness and low average discharge potential, and can thus be combined with a cathode to achieve a high energy density. The anode active material is also preferably a mixture of graphite and silicon with a Si content of equal to or greater than 5%, further preferably equal to or greater than 10%, with respect to carbon (C) which constitutes the graphite.

The anode mix may be prepared by, for example, a method of applying pressure to the anode active material on the anode current collector or a method of using an appropriate organic solvent so that the anode active material is in a paste form.

The anode current collector is, for example, Cu, Ni, or stainless steel, among which Cu is preferable because Cu is not easily alloyed with lithium in the case of a lithium ion secondary battery and is easily processed into a thin film.

The sheet-shaped anode may be produced, that is, the anode mix may be supported by the anode current collector, by, for example, a method of applying pressure to the anode active material on the anode current collector to form an anode mix thereon or a method of (i) using an appropriate organic solvent so that the anode active material is in a paste form to provide an anode mix, (ii) applying the anode mix to the anode current collector, (iii) drying the applied anode mix to prepare a sheet-shaped anode mix, and (iv) applying pressure to the sheet-shaped anode mix so that the sheet-shaped anode mix is firmly fixed to the anode current collector. The paste preferably contains the above-described electrically conductive material and binding agent.

The nonaqueous electrolyte secondary battery member in accordance with an embodiment of the present invention can be produced by, for example, arranging the cathode, the porous film or the laminated body, and the anode in this order. The nonaqueous electrolyte secondary battery in accordance with an embodiment of the present invention can be produced by (i) forming the nonaqueous electrolyte secondary battery member as described above, (ii) inserting the nonaqueous electrolyte secondary battery member into a container for use as a housing of the nonaqueous electrolyte secondary battery, (iii) filling the container with a nonaqueous electrolyte solution, and (iv) hermetically sealing the container under reduced pressure. The nonaqueous electrolyte secondary battery is not limited to any particular shape, and can have any shape such as the shape of a thin plate (sheet), a disk, a cylinder, or a prism such as a cuboid. A method of producing each of the nonaqueous electrolyte secondary battery member and the nonaqueous electrolyte secondary battery is not limited to any particular one, and can be any conventionally known method.

A nonaqueous electrolyte secondary battery member in accordance with an embodiment of the present invention and a nonaqueous electrolyte secondary battery in accordance with an embodiment of the present invention each include, as a separator or as a member of a separator, a porous film which has a piercing strength of equal to or greater than 26.0 gf/g/m² as measured with respect to a weight per unit area of the porous film and which satisfies the Formula (1). Therefore, surface-wise uniformity in distance between electrodes is maintained even in a case where an electrode composite expands -during charge/discharge. Hence, the nonaqueous electrolyte secondary battery in accordance with an embodiment of the present invention and a nonaqueous electrolyte secondary battery including the nonaqueous electrolyte secondary battery member in accordance with an embodiment of the present invention each have (i) an excellent discharge output characteristic and (ii) an even more increased rate characteristic maintaining ratio after a charge-discharge cycle.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### EXAMPLES

The following description will discuss an embodiment of the present invention in more detail by Examples and Comparative Examples. Note, however, that an embodiment of the present invention is not limited to these Examples.

[Measurement]

In each of Examples and Comparative Examples below, (i) a critical load value of a nonaqueous electrolyte secondary battery separator, (ii) a ratio of a critical load distance in a traverse direction to a critical load distance in a machine direction (T/M) of the nonaqueous electrolyte secondary battery separator, and (iii) a cycle characteristic of a nonaqueous electrolyte secondary battery, were measured by the following method.

(Scratch Test)

The critical load value and the ratio of a critical load distance in a traverse direction to a critical load distance in a machine direction (T/M) were measured by a scratch test. Any conditions and the like for the measurement other than the conditions described below are similar to those disclosed in JIS R 3255. In addition, a measurement apparatus used was a microscratch testing device (manufactured by CSM Instruments).
(1) A porous film produced in each of Examples and Comparative Examples was cut into a piece of 20 mm×60 mm. Then, a preparation was made by combining the piece of the porous film and a glass plate of 30 mm×70 mm by the use of glue which had been (i) obtained by 5-fold dilution of Arabic Yamato aqueous liquid glue (manufactured by YAMATO Co., Ltd.) with the use of water and (ii) thinly applied to an entire surface of the glass plate in as small an amount as weight per unit area of approximately 1.5 g/m². Then, the preparation was dried at a temperature of 25° C. for one whole day and night, so that a test sample was prepared. Note that the piece of the porous film and the glass plate were combined with care so that no air bubble would be made between the piece of the porous film and the glass plate.
(2) The test sample prepared in the step (1) was placed on a micro scratch testing device (manufactured by CSM Instruments). Then, while a diamond indenter (in a conical shape having an apex angle of 120° and having a tip whose radius is 0.2 mm) of the testing device was applying a vertical load of 0.1 N to the test sample, a table of the testing device was moved by a distance of 10 mm in a traverse direction of the porous film at a speed of 5 mm/min. During the movement of the table, stress (force of friction) that occurred between the diamond indenter and the test sample was measured.
(3) A line graph, which shows a relationship between a displacement of the stress measured in the step (2) and the distance of the movement of the table, was made. Then, based on the line graph, the following were calculated: (i) a critical load value in the traverse direction and (ii) a distance (critical load distance) in the traverse direction between a starting point of measurement and a point where the critical load was obtained.
(4) The direction of the movement of the table was changed to a machine direction, and the above steps (1) through (3) were repeated. Then, the following were calculated: (i) a critical load value in the machine direction and (ii) the distance (critical load distance) in the machine direction between a starting point of measurement and a point where the critical load was obtained.

(Cycle Test)

A new nonaqueous electrolyte secondary battery which had been produced in each of Examples and Comparative Examples and which had not been subjected to any cycle of charge/discharge was subjected to four cycles of initial charge/discharge. Each cycle of the initial charge/discharge was performed under conditions that the temperature was 25° C. the voltage range was 4.1 V to 2.7 V, and the current value was 0.2 C (1 C is defined as a value of a current at which a rated capacity based on a discharge capacity at 1 hour rate is discharged for 1 hour. The same is applied hereinafter).

Subsequently, an initial battery characteristic maintaining ratio at 55° C. was calculated according to the following Formula (4).

Initial battery characteristic maintaining ratio (%)=(discharge capacity at 20 C/discharge capacity at 0.2 C)×100 (4)

Subsequently, the nonaqueous electrolyte secondary battery was subjected to 100 cycles of charge/discharge, with each cycle being performed under conditions that (i) the temperature was 55° C. and (ii) constant currents were a charge current value of 1.0 C and a discharge current value of 10 C. Then, a battery characteristic maintaining ratio after 100 cycles was calculated according to the following Formula 15).

Battery characteristic maintaining ratio (%)=(discharge capacity at 20 C at 100th cycle/discharge capacity at 0.2 C at 100th cycle)×100 (5)

(Measurement of Piercing Strength)

A porous film was fixed with a washer of 12 mmφ by use of a handy-type compression tester (KATO TECH CO., LTD.; model No. KES-G5). Piercing strength of the porous film was defined as a maximum stress (gf) obtained by piercing the porous, film with a pin at 200 mm/min. The pin used in the measurement had a pin diameter of 1 mmφ and a tip radius of 0.5 R.

### Example 1

<Production of Nonaqueous Electrolyte Secondary Battery Separator>

Ultra-high molecular weight polyethylene powder (GUR4032, manufactured by Ticona Corporation) and polyethylene wax (FNP-011S, manufactured by Nippon Seiro Co., Ltd.) having a weight-average molecular weight of 1000 were mixed at a ratio of 72 weight %:29 weight %. Then, to 100 parts by weight of a mixture of the ultra-high molecular weight polyethylene and the polyethylene wax, the following were added: 0.4 parts by weight of antioxidant (Irg1010, manufactured by Ciba Specialty Chemicals Inc.), 0.1 parts by weight of antioxidant (P168, manufactured by Ciba Specialty Chemicals Inc.), and 1.3 parts by weight of sodium stearate. Then, calcium carbonate (manufactured by Maruo Calcium Co., Ltd.) having an average pore size of 0.1 μm was further added so as to account for 37% by volume of a total volume of the resultant mixture. Then, the resultant mixture while remaining a powder was mixed with the use of a Henschel mixer, so that a mixture 1 was obtained. Then, the mixture 1 was melted and kneaded with the use of a twin screw kneading extruder, so that a polyolefin resin composition 1 was obtained. Then, the polyolefin resin composition 1 was rolled with the use of a rolling mill roll at a circumferential velocity of 4.0 m/min, so that a rolled sheet 1 was obtained. Then, the rolled sheet 1 was immersed in a hydrochloric acid aqueous solution (containing 4 mol/L of hydrochloric acid and 0.5 weight % of a nonionic surfactant) so as to remove the calcium carbonate from the rolled sheet 1. Then, the resultant sheet was stretched with a stretch magnification of 7.0 times (ratio of the stretch temperature to the stretch magnification=14.3) at 100° C. Furthermore, the resultant sheet, was heat fixed at 123° C. so that a porous film 1 was obtained. The weight per unit area of the porous film 1 thus obtained was 5.4 g/m². The porous film 1 thus obtained was designated as a nonaqueous electrolyte secondary battery separator 1.

<Preparation of Nonaqueous Electrolyte Secondary Battery>

(Cathode)

A commercially available cathode, which was produced by coating an aluminum foil with a mixture of LiNi_{0.5}Mn_{0.3}Co_{0.2}O₂, an electrically conductive material, and PVDF (at a weight ratio of 92:5:3), was used. The aluminum foil was cut off to be a cathode so that a part in which no cathode active material layer was provided and which had a width of 13 mm was left around a part in which a cathode active material layer was provided and which had a size of 40 mm×35 mm. The cathode active material layer had a thickness of 58 μm and a density of 2.50 g/cm³.

(Anode)

A commercially available anode, which was produced by coating a copper foil with a mixture of graphite, styrene-1,3-butadiene copolymer, and sodium carboxymethyl cellulose (at a weight ratio of 98:1:1), was used. The copper foil was cut off to be an anode so that a part in which no anode active material layer was provided and which had a width of 13 mm was left around a part in which an anode active material layer was provided and which had a size of 50 mm×40 mm. The anode active material layer had a thickness of 49 μm and a density of 1.40 g/cm³.

(Preparation of Nonaqueous Electrolyte Secondary Battery)

The cathode, the porous film 1 (electrolyte secondary battery separator 1), and the anode were laminated (arranged) in this order in a laminate pouch, so that a nonaqueous electrolyte secondary battery member 1 was obtained. In so doing, the cathode and the anode were arranged so that a main surface in the cathode active material layer of the cathode was entirely included in a range of a main surface in the anode active material layer of the anode (i.e. overlapped the main surface in the active material layer).

Subsequently, the nonaqueous electrolyte secondary battery member 1 was put in a bag which had been prepared by laminating an aluminum layer and a heat seal layer, and 0.25 mL of a nonaqueous electrolyte solution was poured into the bag. The above nonaqueous electrolyte solution was prepared by dissolving LiPF₆ in a mixed solvent of ethylene carbonate, ethyl methyl carbonate, and diethyl carbonate at a ratio of 3:5:2 (volume ratio) so that the LiPF₆ would be contained at 1 mol/L. The bag was heat-sealed while a pressure inside the bag was reduced, so that a nonaqueous electrolyte secondary battery 1 was produced.

### Example 2

A polyolefin resin composition 2 was obtained as in Example 1 except that (i) the amount of ultra-high molecular weight polyethylene powder (GUR4032, manufactured by Ticona Corporation) was set to 70 weight %, (ii) the amount of polyethylene wax (FNP-0115, manufactured by Nippon Seiro Co., Ltd.) having a weight-average molecular weight of 1000 was set to 30 weight %, and (iii) calcium carbonate (manufactured by Maruo Calcium Co., Ltd.) having an average pore size of 0.1 μm was used so as to account for 36% by volume of a total volume of the resultant mixture. Then, the polyolefin resin composition 2 was rolled with the use of a rolling mill roll at a circumferential velocity of 3.0 m/min, so that a rolled sheet 2 was prepared. Then, the rolled sheet 2 was subjected to removal of the calcium carbonate, stretching, and heat fixing as in Example 1 except that (i) the stretch temperature was set to 105° C., (ii) the stretch magnification was set to 6.2 times (ratio of the stretch temperature to the stretch magnification=16.9), and (iii) the heat fixing temperature was set to 120° C., so that a porous film 2 was obtained. The weight per unit area of the porous film 2 thus obtained was 6.9 g/m². The porous film 2 thus obtained was designated as a nonaqueous electrolyte secondary battery separator 2.

A nonaqueous electrolyte secondary battery 2 was prepared by a method similar to that used in Example 1 except that the porous film 2 was used instead of the porous film 1.

### Example 3

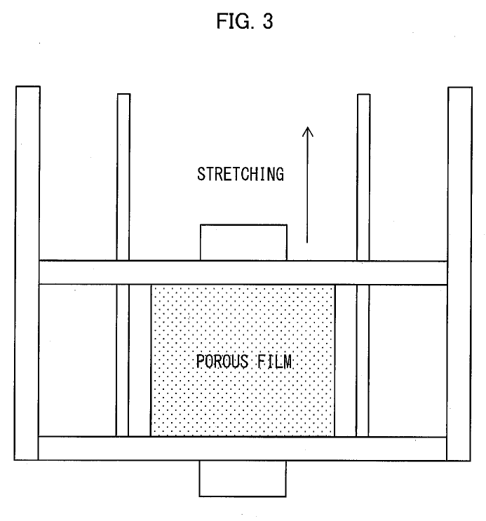

A piece of 5 cm×5 cm was cut out from the porous film 1 obtained in Example 1. Then, the piece of the porous film 1 was (i) fixed, with the use of a tape, to an SUS (stainless steel) jig having frame dimensions of 15 cm×15 cm as illustrated in FIG. 3. Then, with the use of Compact Table-Top Universal Tester (EZ-L) (manufactured by Shimadzu Corporation) in which a thermostatic chamber was provided, the piece of the porous film 1 was further stretched at 85° C. so that the length in the machine direction would be 1.5 times as long. This resulted in a porous film 3.

The porous film 3 was designated as a nonaqueous electrolyte secondary battery separator 3.

A nonaqueous electrolyte secondary battery 3 was prepared by a method similar to that used in Example 1 except that the porous film 3 was used instead of the porous film 1.

### Example 4

A piece of 5 cm×5 cm was cut out from the porous film 1 obtained in Example 1. Then, the piece of the porous film 1 was (i) fixed, with the use of a tape, to a SUS jig having frame dimensions of 15 cm×15 cm as illustrated in FIG. 3. Then, with the use of Compact Table-Top Universal Tester (EZ-L) (manufactured by Shimadzu Corporation) in which a thermostatic chamber was provided, the piece of the porous film 1 was further stretched at 85° C. so that the length in the machine direction would be 1.2 times as long. This resulted in a porous film 4.

The porous film 4 was designated as a nonaqueous electrolyte secondary battery separator 4.

A nonaqueous electrolyte secondary battery 4 was prepared by a method similar to that used in Example 1 except that the porous film 4 was used instead of the porous film 1.

### Comparative Example 1

Ultra-high molecular weight polyethylene powder (GUR2024, manufactured by Ticona Corporation) and polyethylene wax (FNP-0115, manufactured by Nippon Seiro Co., Ltd.) having a weight-average molecular weight of 1000 were mixed at a ratio of 68 weight %:32 weight %. Then, to 100 parts by weight of a mixture of the ultra-high molecular weight polyethylene and the polyethylene wax, the following were added: 0.4 parts by weight of antioxidant (Irg1010, manufactured by Ciba Specially Chemicals Inc.), 0.1 parts by weight of antioxidant (P168, manufactured by Ciba Specialty Chemicals Inc.), and 1.3 parts by weight of sodium stearate. Then, calcium carbonate (manufactured by Maruo Calcium Co., Ltd.) having an average pore size of 0.1 μm was further added so as to account for 38% by volume of a total volume of the resultant mixture. Then, the resultant mixture while remaining a powder was mixed with the use of a Hensehel mixer, so that a mixture 5 was obtained. Then, the mixture 5 was melted and kneaded with the use of a twin screw kneading extruder, so that a polyolefin resin composition 5 was obtained. Then, the polyolefin resin composition 5 was rolled with the use of a rolling mill roll at a circumferential velocity of 2.5 m/min, so that a rolled sheet 5 was obtained. Then, the rolled sheet 5 was immersed in a hydrochloric acid aqueous solution (containing 4 mol/L of hydrochloric acid, and 0.5 weight % of a nonionic surfactant) so as to remove the calcium carbonate from the rolled sheet 5. Then, the resultant sheet was stretched with a stretch magnification of 6.2 times (ratio of the stretch temperature to the stretch magnification=16.1) at 100° C. Furthermore, the resultant sheet was heat fixed at 126° C. so that a porous film 5 was obtained. The weight per unit area of the porous film 5 thus obtained was 6.4 g/m². The porous film 5 thus obtained was designated as a nonaqueous electrolyte secondary battery separator 5.

A nonaqueous electrolyte secondary battery 5 was prepared by a method similar to that used in Example 1 except that the porous film 5 was used instead of the porous film 1.

### Example 5

A piece of 5 cm×5 cm was cut out from the porous film 5 obtained in Comparative Example 1. Then, the piece of the porous film 5 was (i) fixed, with the use of a tape, to an SUS (stainless steel) jig having frame dimensions of 15 cm×15 cm as illustrated in FIG. 3. Then, with the use of Compact Table-Top Universal Tester (EZ-L) (manufactured by Shimadzu Corporation) in which a thermostatic chamber was provided, the piece of the porous film 5 was further stretched at 85° C. so that the length in the machine direction would be 1.5 times as long. This resulted in a porous film 6.

The porous film 6 was designated as a nonaqueous electrolyte secondary battery separator 6.

A nonaqueous electrolyte secondary battery 6 was prepared by a method similar to that used in Example 1 except that the porous film 6 was used instead of the porous film 1.

### Comparative Example 2

A commercially available polyolefin separator (weight per unit area: 13.9 g/m²) was designated as a porous film 7 (nonaqueous electrolyte secondary battery separator 7).

A nonaqueous electrolyte secondary battery 7 was prepared by a method similar to that used in Example 1 except that the porous film 7 was used instead of the porous film 1.

Table 1 below shows the circumferential velocities, the stretch temperatures, the stretch magnifications, and ratios of the stretch temperatures to the corresponding stretch magnifications of the rolling mill rolls used in Examples 1 and 2 and Comparative Example 1.

TABLE 1

| | | | | Stretch |
|---|---|---|---|---|
| | Circumferential | | | temperature/ |
| | velocity of | Stretch | Stretch | stretch |
| | rolling mill roll | temperature | magnification | magnification |
| | [m/min] | [° C.] | [%] | [° C./%] |
| Example 1 | 4.0 | 100 | 700 | 14.3 |
| Example 2 | 3.0 | 105 | 620 | 16.9 |
| Comparative | 2.5 | 100 | 620 | 16.1 |
| Example 1 | | | | |

[Measurement Results]

Each, of the nonaqueous electrolyte secondary battery separators 1 through 7 obtained in Examples 1 through 5 and Comparative Examples 1 and 2 was subjected to the scratch test so as to measure (i) respective “critical loads” in a traverse direction and in a machine direction and (ii) respective “critical load distances” in the traverse direction and in the machine direction. The results are shown in Table 2.

In addition, a cycle characteristic of each of the nonaqueous electrolyte secondary batteries 1 through 7 obtained in Examples 1 through 5 and Comparative Examples 1 and 2 was measured. The results are shown, in Table 2.

TABLE 2

| | | | | Distance to | | |
|---|---|---|---|---|---|---|
| | Piercing | | | critical load | | |
| | strength | | | (critical | | |
| | with | | | point) | | |
| | respect to | | | (critical | | Rate |
| | volume | | | load | | characteristic |
| | per unit area | Scratching | Critical | distance) | | after 100 |
| | [gf/(g/m²)] | direction | load | [mm] | \|1-T/M\| | cycles [%] |
| Example 1 | 64.1 | MD | 0.23 | 3.82 | 0.37 | 55 |
| | | TD | 0.19 | 2.42 | | |
| Example 2 | 52.5 | MD | 0.18 | 4.84 | 0.42 | 52 |
| | | TD | 0.21 | 2.83 | | |
| Example 3 | 53.5 | MD | 0.21 | 2.60 | 0.23 | 63 |
| | | TD | 0.19 | 2.00 | | |
| Example 4 | 57.2 | MD | 0.22 | 3.54 | 0.46 | 45 |
| | | TD | 0.21 | 1.92 | | |
| Example 5 | 63.4 | MD | 0.22 | 2.59 | 0.31 | 58 |
| | | TD | 0.20 | 1.78 | | |
| Comparative | 67.0 | MD | 0.20 | 4.53 | 0.55 | 37 |
| Example 1 | | TD | 0.19 | 2.06 | | |
| Comparative | 25.0 | MD | 0.24 | 4.18 | 0.57 | 18 |
| Example 2 | | TD | 0.19 | 1.80 | | |

[Conclusion]

As shown in Table 2, (i) according to each of the nonaqueous electrolyte secondary battery separators 5 and 7 produced in Comparative Examples 1 and 2, respectively, the value of “1−T/M” was greater than 0.54, that is, the value of “T/M” was less than 0.46, which means that critical load distances in scratch tests were highly anisotropic and (ii) the nonaqueous electrolyte secondary batteries 5 and 7, which included the nonaqueous electrolyte secondary battery separators 5 and 7, respectively, had such significantly low rate characteristics (battery characteristic maintaining ratios) after 100 cycles as 37% and 18%, respectively.

Meanwhile, (i) according to each of the nonaqueous electrolyte secondary battery separators 1 through 4 and 6 produced in Examples 1 through 5, respectively, the value of “1−T/M” was 0.00 to 0.54, that is, the value of “T/M” was 0.45 to 1.00, which means that critical load distances in scratch tests were slightly anisotropic and (ii) the nonaqueous secondary batteries 1 through 4 and 6, which included the nonaqueous electrolyte secondary battery separators 1 through 4 and 6, respectively, each had a rate characteristic (battery characteristic; maintaining ratio) after 100 cycles of equal to or greater than 45%. This confirmed that the cycle characteristics of the nonaqueous secondary batteries 1 through 4 and 6 were superior.

### INDUSTRIAL APPLICABILITY

A nonaqueous electrolyte secondary battery separator in accordance with an embodiment of the present invention and a nonaqueous electrolyte secondary battery laminated separator in accordance with an embodiment of the present invention are each suitable for production of a nonaqueous electrolyte secondary battery having an excellent discharge output characteristic, particularly an excellent cycle characteristic.

### REFERENCE SIGNS LIST

1 Diamond indenter

2 Substrate (glass plate)

3 Porous film containing polyolefin resin as a main component

1. A nonaqueous electrolyte secondary battery separator which is a porous film containing a polyolefin resin as a main component,
the nonaqueous electrolyte secondary battery separator having a piercing strength of equal to or greater than 26.0 gf/g/m², which piercing strength is measured with respect to a weight per unit area of the porous film, and
the nonaqueous electrolyte, secondary battery separator having a value in a range of 0.00 to 0.54, which value is represented by the following Formula (1):

|1−T/M| (1)
where (i) T represents a distance by which the porous film moves in a traverse direction from a starting point of measurement to a point where a critical load is obtained in a scratch test under a constant load of 0.1 N and, (ii) M represents a distance by which the porous film moves in a machine direction from a starting point of measurement to a point where a critical load is obtained in a scratch test under a constant load of 0.1 N.

2. The nonaqueous electrolyte secondary battery separator as set forth in claim 1, wherein
a value represented by the following Formula (2) is in a range of 0.00 to 0.54:
1−T/M (2)
where (i) T represents a distance by which the porous film moves in a traverse direction from a starting point of measurement to a point where a critical load is obtained in a scratch test under a constant load of 0.1 N and (ii) M represents a distance by which the porous film moves in a machine direction from a starting point of measurement to a point where a critical load is obtained in a scratch test under a constant load of 0.1 N.

3. A nonaqueous electrolyte secondary battery laminated separator comprising:
a nonaqueous electrolyte secondary battery separator recited in claim 1; and
a porous layer laminated on at least one surface of the nonaqueous electrolyte secondary battery separator.

4. The nonaqueous electrolyte secondary battery laminated separator as set forth in claim 3, wherein
the porous layer contains a heat-resistant resin.

5. The nonaqueous electrolyte secondary battery laminated separator as set forth in claim 3, wherein
the porous layer contains a polyvinylidene fluoride-based resin.

6. The nonaqueous electrolyte secondary battery laminated separator as set forth in claim 3, wherein
the porous layer contains electrically insulating fine particles.

7. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being arranged in this order.

8. A nonaqueous electrolyte secondary battery member comprising:
a cathode;
a nonaqueous electrolyte secondary battery laminated separator recited in claim 3; and
an anode,
the cathode, the nonaqueous electrolyte secondary battery laminated separator, and the anode being arranged in this order.

9. A nonaqueous electrolyte secondary battery comprising:
a nonaqueous electrolyte secondary battery separator recited in claim 1.

10. A nonaqueous electrolyte secondary battery comprising:
a nonaqueous electrolyte secondary battery laminated separator recited in claim 3.
